(19) United States
(12) Patent Application Publication
(10) Pub. No.: US 2012/0037020 A1
(43) Pub. Date: Feb. 16, 2012

(54) DEVICE AND METHOD FOR PRODUCING PACKAGES FOR CIGARETTES

(75) Inventors: Thomas Häfker, Langwedel (DE); Heiko Köhler, Verden (DE)

(73) Assignee: FOCKE & CO. (GMBH & CO, KG), Verden (DE)

(21) Appl. No.: 13/260,615

(22) PCT Filed: Feb. 19, 2010
(86) PCT No.: PCT/EP2010/001039

§ 371 Date: Sep. 27, 2011

(30) Foreign Application Priority Data
Apr. 24, 2009 (DE) 10 2009 018 561.5

(51) Int. Cl. B41F 5/00

(52) U.S. Cl. 101/216; 101/483

(57) ABSTRACT

A method of, and an apparatus for, producing packs for cigarettes, having a continuously driven conveyor, such as a transporting belt with drivers, for transporting the packs, and having an arrangement for applying printing carriers, such as labels, coupons or the like, to a side surface of the packs, the arrangement for applying the printing carriers being arranged in the region of the conveyor, for the purpose of applying the printing carriers to a side surface of the pack, this side surface being directed toward the arrangement, during transportation along the conveyor. A pivoting arrangement for altering the relative position of the packs is arranged in the region of the conveyor and/or of the arrangement for applying the printing carriers, wherein the pivoting arrangement is set up for receiving a respective pack in a relative position appropriate for transportation on the conveyor, and for rotating the pack into a relative position suitable for applying the printing carrier, and for further rotating the pack into a relative position appropriate for further transportation on the conveyor.

### BACKGROUND OF THE INVENTION

1. Technical Field

The invention relates to an apparatus for producing packs for cigarettes, having a continuously driven conveying means, in particular a transporting belt with drivers, for transporting the packs, and having an arrangement for applying printing carriers, such as labels, coupons or the like, to a side surface of the packs, wherein the arrangement for applying the printing carriers is arranged in the region of the conveying means, for the purpose of applying the printing carriers to a side surface of the pack, this side surface being directed toward the arrangement, during transportation along the conveying means. The invention also relates to a corresponding method of producing packs for cigarettes, wherein the packs are transported continuously along a conveying means and, in the region of an arrangement for applying printing carriers, such as labels, coupons or the like, to side surfaces of the packs, are provided as printing carriers.

2. Prior Art

The operation of applying printing carriers in the form of labels to side surfaces of cigarette packs is known in principle. The labels may be, for example, revenue stamps. The present invention is concerned, in particular, with the operation of applying such labels in the region of narrow side surfaces of cigarette packs. Legal requirements, for example the obligation to apply a health warning message to the cigarette pack, barcodes or the like, mean that the surface area available for the design of the cigarette pack is getting smaller and smaller. In this respect, applying the label exclusively in the region of the narrow side surfaces is advantageous because this means that the large-surface-area front side and rear side of the pack are not concealed by the label.

A basic problem, however, is that of retrofitting existing packaging machines, in order for it to be possible for the packs to be provided with a label in the region of the narrow side surfaces. The layout of the installation usually has to be altered for this purpose, which, in the case of systems which have already been set up, gives rise to considerable outlay and technical problems.

### BACKGROUND OF THE INVENTION

Taking this as a departure point, it is an object of the present invention to propose an apparatus which makes it possible in a straightforward manner to alter the relative position of the packs in conjunction with the operation of applying printing carriers and which can be integrated preferably straightforwardly in existing installations.

In order to achieve this object, an apparatus according to the invention is an apparatus for producing packs for cigarettes, having a continuously driven conveying means, in particular a transporting belt with drivers, for transporting the packs, and having an arrangement for applying printing carriers, such as labels, coupons or the like, to a side surface of the packs, wherein the arrangement for applying the printing carriers is arranged in the region of the conveying means, for the purpose of applying the printing carriers to a side surface of the pack, this side surface being directed toward the arrangement, during transportation along the conveying means, characterized in that a pivoting arrangement for altering the relative position of the packs is arranged in the region of the conveying means and/or of the arrangement for applying the printing carriers, wherein the pivoting arrangement is set up for receiving a respective pack in a relative position appropriate for transportation on the conveying means, and for rotating the pack into a relative position suitable for applying the printing carrier, and for further rotating the pack into a relative position appropriate for further transportation on the conveying means. Accordingly, it is provided that a pivoting arrangement for altering the relative position of the packs is arranged in the region of the conveying means and/or of the arrangement for applying the printing carriers, wherein the pivoting arrangement is set up for receiving a respective pack in a relative position appropriate for transportation on the conveying means, and for rotating the pack into a relative position suitable for applying the printing carrier, and for further rotating the pack into a relative position appropriate for further transportation on the conveying means.

The pivoting arrangement allows the relative position of the pack to be altered in adaptation to the set-up and operating position of the arrangement for applying the printing carrier, and/or for adaptation to the relative position of the packs on the conveying means. It is thus possible for the pivoting arrangement and the arrangement for applying the printing carriers to be integrated in an existing conveying path, without it being necessary to alter the conveying path itself or the alignment of the pack during transportation along the conveying path. This is catered for by the pivoting arrangement, which feeds the packs in a correctly positioned state to the arrangement for applying the printing carriers and sets the packs down again on the conveying means in the original relative position.

According to a preferred embodiment, it is provided that the pivoting arrangement has a holder for a pack, into which an individual pack can be pushed by the conveying means, and that the holder can be rotated by a gear mechanism such that that side surface of the pack which is to be provided with the printing carrier can be directed toward the arrangement for applying the printing carriers and, once the printing carrier has been applied, can be rotated back into the original relative position, and the pack can be transferred onto the conveying means.

The holder, for example in the form of a cassette, thus receives the pack from the conveying means and turns the corresponding side surface—preferably a narrow side surface—toward the arrangement for applying the printing carriers. Thereafter, the pivoting arrangement turns the pack back into the original relative position and transfers the pack, provided with the printing carrier, onto the conveying means. The pack can then be processed further in the usual manner. As an alternative, once the printing carrier has been applied, the rotary arrangement can also rotate the pack into a relative position on the conveying means other than the original relative position. In the case of being integrated into an existing installation, further adaptations may then be required. In the case of a new installation, the pivoting arrangement may thus also be utilized in order to alter the relative position.

It is often the case in practice that the packs are arranged on the conveying means in a state in which they lie flat and have a narrow side surface oriented in the conveying direction, and that, by means of the pivoting arrangement, the packs can be directed, with a narrow side surface oriented upward, toward the arrangement for applying the printing carriers, this arrangement being arranged above the conveying means.

A further special feature provides that the packs are accumulated in the region of an entry station and can be fed individually to a turning arrangement for rotating and separating the packs and transferring the packs onto the conveying means. Further details of the turning arrangement can be gathered elsewhere in the description. The accumulation of packs and the turning arrangement aid straightforward connection to the conveying means with the pivoting arrangement. The accumulation of packs may also be utilized in order to control the operation of the machines downstream.

In design terms, the procedure may be such that the holder for the pack is mounted on a rocker such that it can be pivoted on either side of the conveying means, wherein the rocker is mounted in a pivotable manner on rocker bearings and can be moved along an imaginary curve, together with the holder, via a drive, and that the holder for the packs can be rotated about the bearing point on the rocker via a lever.

In respect of the drive of the apparatus, the procedure may be such that the lever for rotating the holder and a lever for moving the rocker can be driven by a gear mechanism with a common drive. As an alternative, it is conceivable for this to be realized by separate drives, in particular individually actuable servomotors. Servomotor control here provides several advantages in respect of adapting the movement path of the rocker and of the holder to different types of pack, in particular packs with printing carriers positioned on different side surfaces. Further details in this respect can be gathered elsewhere in the description.

Once the printing carrier has been applied, the packs are fed to an arrangement for wrapping the packs in a preferably transparent outer wrapper.

A method according to the invention is a method of producing packs for cigarettes, wherein the packs are transported continuously along a conveying means and, in the region of an arrangement for applying printing carriers, such as labels, coupons or the like, to side surfaces of the packs, are provided as printing carriers, characterized in that the packs are rotated in respect of their relative position in the region of a pivoting arrangement, during transportation along the conveying means, such that the side surface which is to be provided with the printing carrier is directed toward the arrangement for applying the printing carriers, and in that the pivoting arrangement rotates the packs, once the printing carriers have been applied, into a relative position for further transportation on the conveying means, in particular into the original relative position on the conveying means. Accordingly, it is provided that the packs are rotated in respect of their relative position by means of a pivoting arrangement, during transportation along the conveying means, such that the side surface which is to be provided with the printing carrier is directed toward the arrangement for applying the printing carriers, and that the pivoting arrangement rotates the packs, once the printing carriers have been applied, into a relative position for further transportation on the conveying means, in particular into the original relative position on the conveying means.

The method is preferably used such that the packs are pushed from the conveying means into a holder of the pivoting arrangement and, by virtue of the holder being rotated in relation to the conveying means, the packs are moved into a relative position for applying the printing carriers, in particular with a corresponding side surface, preferably a narrow side surface, of the pack oriented upward in the direction of the arrangement for applying the printing carriers.

According to a preferred configuration of the method, the holder, in addition to being rotated, is also accelerated in relation to the conveying means in order to move the pack into the relative position for applying the printing carriers, and in that, once the printing carriers have been applied and the packs have been transferred onto the conveying means, the holder is moved back into a starting position for receiving the next pack.

Once the printing carriers have been applied, the packs can be transferred once again onto the conveying means in order to be fed to a wrapping machine for an outer wrapper.

It is further preferably provided that the packs are transported closely together in the first instance and then, by means of a turning arrangement, are separated and rotated and transferred onto the conveying means for applying the printing carriers.

A further special feature may consist in that, for the purpose of producing packs without printing carriers, the holder for the packs is positioned on the conveying means at a fixed location in the conveying path of the packs such that the packs are conveyed through the fixed-location holder by way of the conveying means. In other words, the holder or the rotary arrangement is brought to a standstill and the packs are conveyed through without being rotated.

Further details of the invention can be gathered elsewhere in the description and the dependent claims.

### BRIEF DESCRIPTION OF THE DRAWINGS

Preferred exemplary embodiments of the invention will be explained hereinbelow with reference to the drawing, in which:

FIG. 1 shows a three-dimensional illustration of a pack for cigarettes.

FIG. 2 shows a three-dimensional illustration of part of an apparatus for producing packs for cigarettes.

FIG. 3 shows a side view of the apparatus according to FIG. 2.

FIG. 4 shows an enlarged three-dimensional illustration of a gear mechanism for driving a pivoting arrangement of the apparatus.

FIGS. 5 to 10 show individual phases which follow one after the other in the operation of applying printing carriers to a pack, in the region of detail V according to FIG. 3.

FIG. 11 shows a vertical section through the apparatus taken along section line XI-XI in FIG. 3.

FIG. 12 shows a partially enlarged side view, analogous to the illustration in FIG. 3, of an alternative apparatus.

### DETAILED DESCRIPTION OF PREFERRED EMBODIMENTS

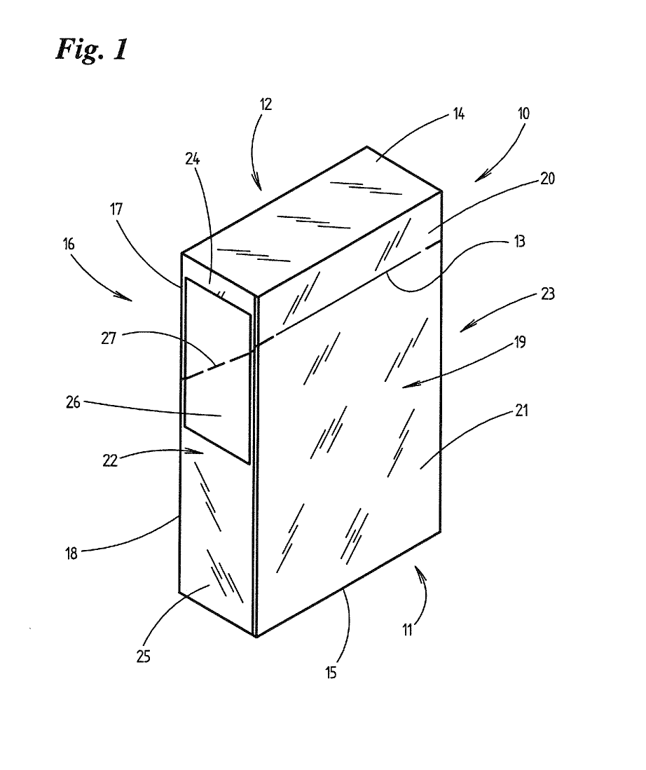

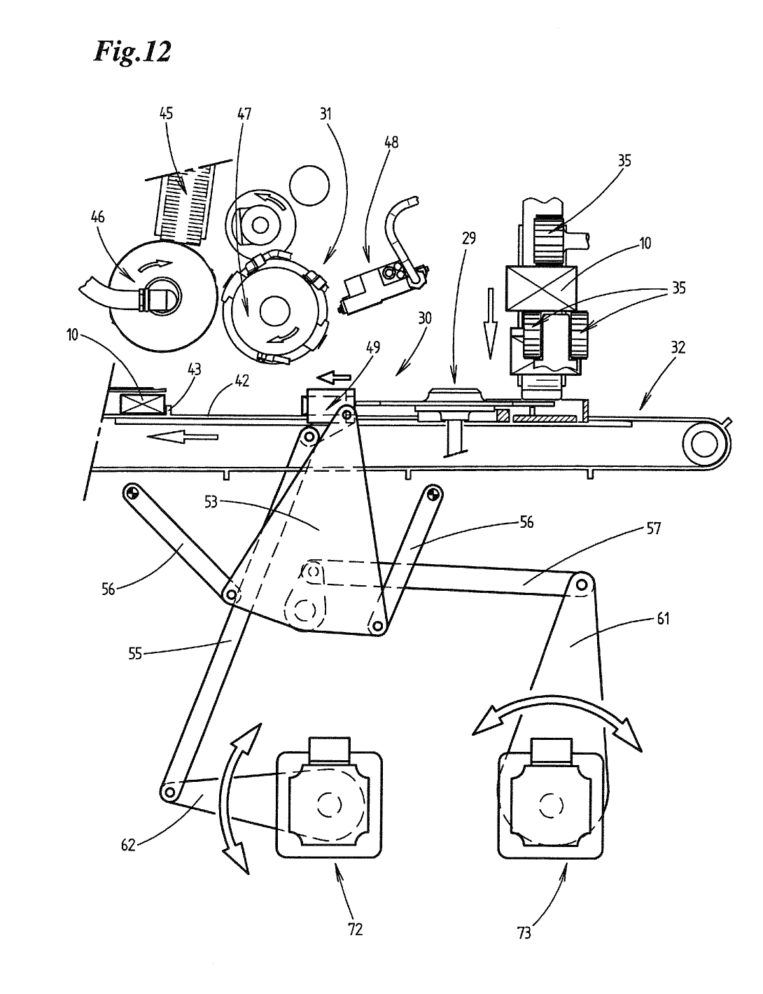

The invention will be described hereinbelow with reference to two exemplary embodiments. A first exemplary embodiment is shown in FIGS. 1 to 11. FIG. 12 shows the essential parts of an alternative configuration, as a second exemplary embodiment.

The two exemplary embodiments relate to the production of packs 10 for cigarettes. The packs 10 shown in the exemplary embodiments are cigarette packs of the hinge-lid type. The packs 10 here are of cuboidal design with a lower box part 11 and an upper lid, which are connected to one another in a pivotable manner via a linear articulation 13.

The packs 10 have an end wall 14 on the upper side of the lid 12 and a base wall 15, located opposite, on the box part 11. Also present is a large-surface-area front side 16, which is formed from a lid front wall 17 and box front wall 18. A rear side 19 is formed opposite the front side 16, and comprises a lid rear wall 20 and box rear wall 21. The linear articulation 13 runs between the lid rear wall 20 and box rear wall 21. Two further side surfaces of the pack 10 are formed by the so-called narrow side surfaces 22, 23, which are located opposite one another and are formed by lid side walls 24 and box side walls 25. In the region of the narrow side surfaces 22, 23, an obliquely directed closing edge runs between the lid 12 and box part 11.

Within the context of this application, the side surfaces of the pack 10 are intended to mean the front side 16, the rear side 19, the narrow side surfaces 22, 23, the end wall 13 and the base wall 15.

In the region of one of the two narrow side surfaces 22, a printing carrier in the form of a label 26 is applied to the pack 10. The label 26 extends merely in the region of the narrow side surface 22, that is to say, in particular, not (also) in the region of the front side 16, rear side 19 or end wall 14. The label 26 extends more or less over the entire width of the narrow side surface 22 in the region of the obliquely directed closing edge between the lid 12 and box part 11. Accordingly, the label 26 is destroyed when the pack 10 is opened for the first time. In order to make it easier for the pack 10 to be opened or used for the first time, the label 26 has a weakening line 27, which is applied along the closing edge. The label 26 is adhesively bonded to the pack 10, for example with glue.

Of course, the apparatus can also be utilized for applying other printing carriers to the pack 10. For example, it is also possible to apply coupons or the like.

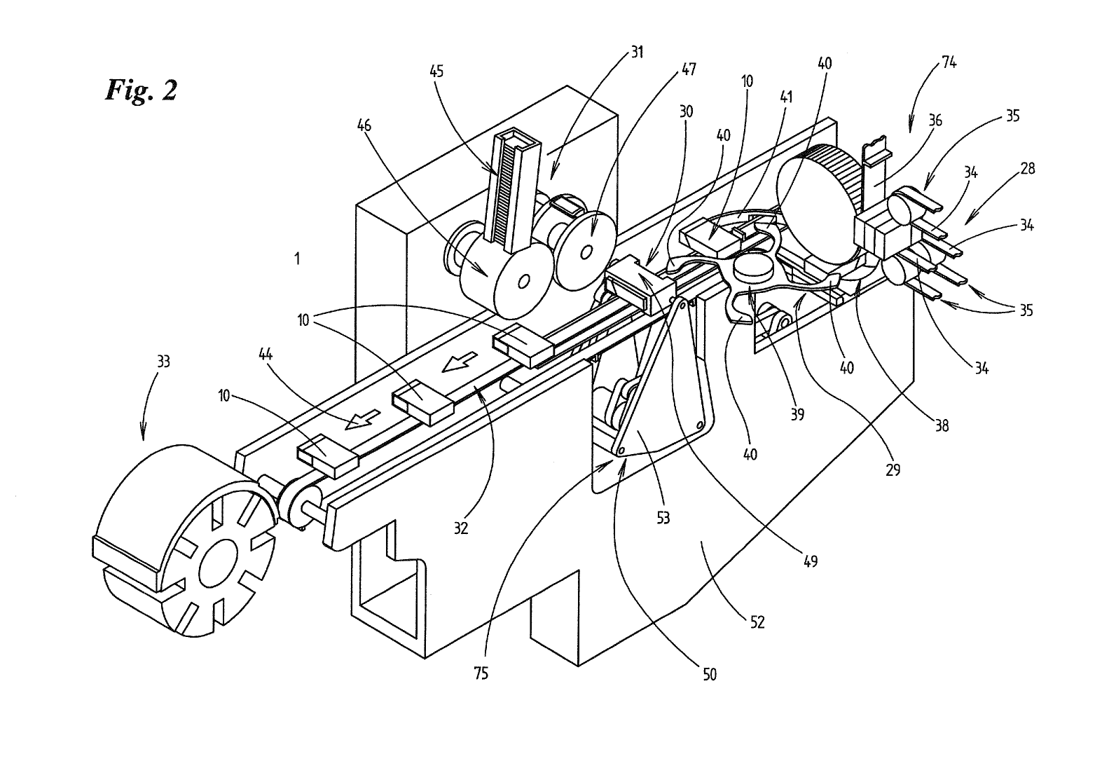

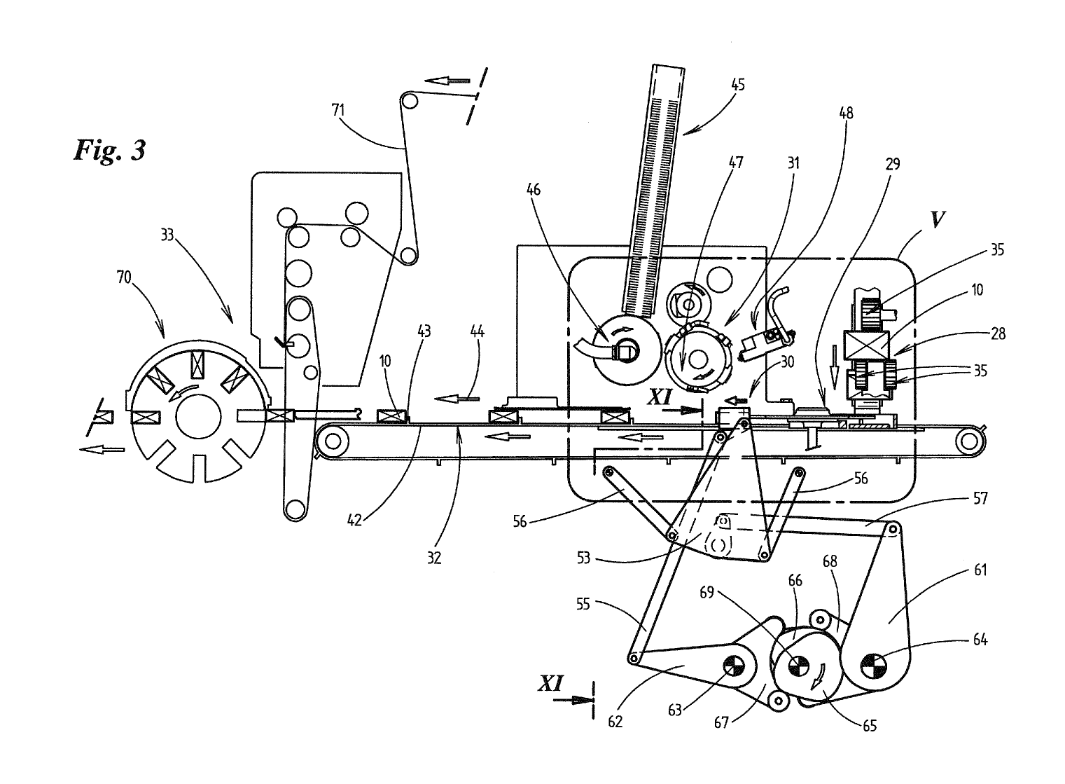

FIGS. 2 and 3 illustrate parts of a packing machine for cigarette packs which are important for the present invention. A complete packing line is disclosed, for example, in the applicant's U.S. Pat. No. 6,751,934 B2. The figures here illustrate the following subassemblies, which follow one after the other in the conveying direction:

1. a first transporting path 28 for packs 10,
2. a turning arrangement 29 for rotating and separating the packs 10,
3. a pivoting arrangement 30 for altering the relative position of the packs 10,
4. an arrangement 31 for applying labels 26 to the packs 10,
5. a conveying means 32 for transporting the packs 10, and
6. a wrapping machine 33 for wrapping the packs 10 in an outer wrapper.

An entry station 74 is formed in the region of the transporting path 28, the packs 10 being transported to the entry station, with the rear side 19 oriented in the conveying direction, and accumulated there. The packs 10 here are transported and retained by conveying strands 34 of endless conveyors 35. The foremost pack 10, as seen in the transporting direction in each case, is carried along, and fed to the pivoting arrangement 30, by drivers 36 of a vertically running transporting belt 37. The spaced-apart arrangement of the drivers 36 of the transporting belt 37 causes the packs 10 to be transported away out of the entry station 74, and separated, in this way.

The separated packs 10 are then moved along a curved conveying portion 38 by the transporting belt 37 and, in the process, are caused to rotate such that the packs 10 are arranged with the front side 16 oriented downward and the narrow side surface 22 oriented in the conveying direction. In this relative position, the packs 10 are gripped by the turning arrangement 29.

The turning arrangement 29 has a revolving star 39 with four radially directed arms 40, which each grip a pack 10 on the rear side and feed the same to the conveying means 32. Accordingly, the revolving star 39 is driven continuously and rotated about a vertical axis. The pack 10 here is transported along an outer guide plate 41 and, in this way, rotated through 90° about an imaginary vertical axis. The packs 10 are thus conveyed onto the conveying means 32, by the revolving star 39, with the front side 16 oriented downward and with the narrow side surface 22 oriented in the conveying direction, the conveying means feeding the packs 10 continuously, at a distance apart from one another, in the direction of the wrapping machine 33.

The conveying means 32, in the present case, is designed as an endless conveyor which transports the packs 10 in a horizontal plane. The belt 42 of the conveying means 32 here has conventionally spaced-apart drivers 43, which grip the packs 10 on the rear side and transport them in the conveying direction according to arrow 44.

An arrangement 31 which is known per se and is intended for applying the labels 26 to the packs 10 is arranged along the conveying means 32. The construction of such a label (or revenue-stamp) apparatus is known, for example, from WO 2007/087885 A1. Essential constituent parts are formed by a label magazine 45, a rotationally driven removal roller 46, a rotationally driven transfer roller 47 and a glue subassembly 48. By means of the removal roller 46, the labels 26 are removed individually from the label magazine 45 and transferred onto the transfer roller 47. On the circumference of the transfer roller 45, the labels 26 are then provided with glue, by means of the glue subassembly 48, and subsequently fed to the pack 10. The label 26 is transferred onto the packs 10 as the latter are being guided along the underside of the transfer roller 47. The operations of transporting the labels 26 and of transporting the packs 10 are coordinated here such that the label 26 ends up located in the desired position on the pack 10.

As can be seen, in particular, from FIG. 3, the arrangement 31 for applying the labels 26 is positioned at a distance above the packs 10, which are transported in a state in which they lie flat on the conveying means 32. In other words, the distance is selected such that the packs 10 can be transported freely beneath the arrangement 31. This may be advantageous, for example, if the packs 10 are not to be provided with a label 26.

Accordingly, for the purpose of applying a label 26, the distance between the packs 10 and the arrangement 31 has to be reduced. In addition, for the purpose of applying the label 26 to the narrow side surface 22, the relative position of the packs 10 has to be altered such that that side surface of the packs 10 which is to be provided with the label 26 is directed toward the transfer mechanism 47. The pivoting arrangement 30 is provided for this purpose.

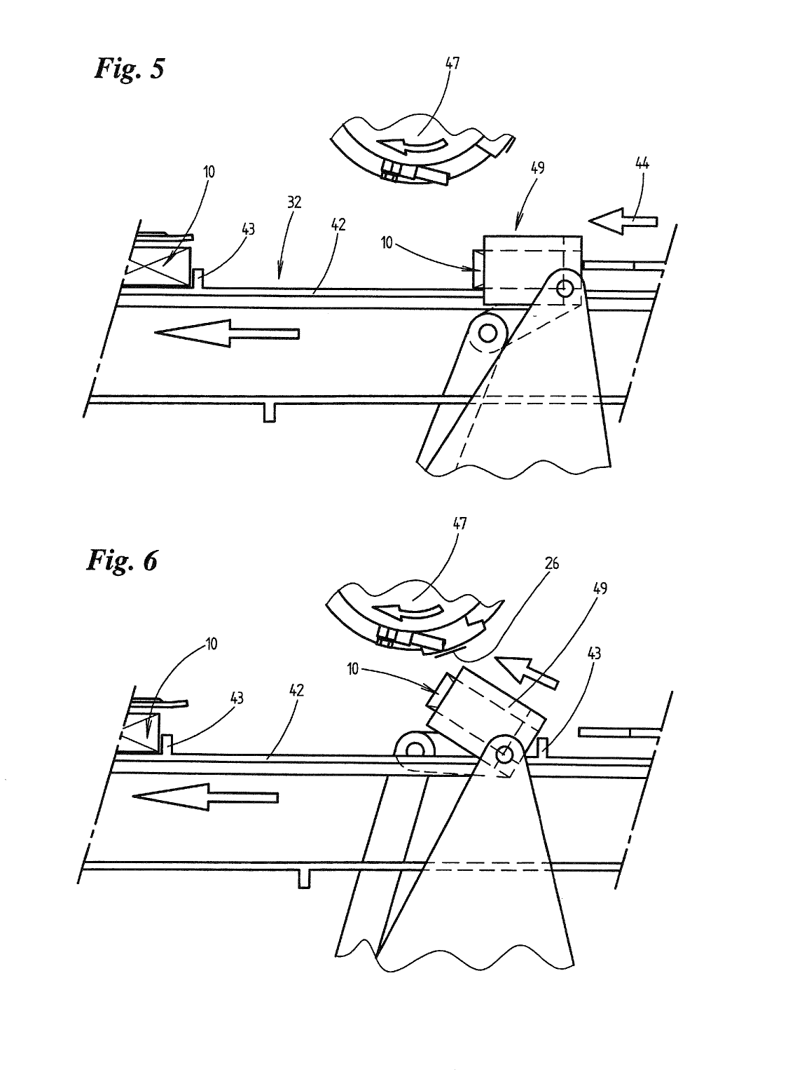

The pivoting arrangement 30 has a holder 49 for a pack 10, it being possible for this holder to be moved, and pivoted and/or rotated in the process, by a gear mechanism 50 along a path which is shown in FIGS. 5 to 10.

The holder 49 is of cassette-like design, with a cross section corresponding to the outer dimensions of the packs 10. The dimensions of the interior of the holder 49 are selected such that a pack 10 can be pushed into the holder 49 and retained by the same. Accordingly, the pack 10 butts against walls of the holder 49. Furthermore, the holder 49 has, on its underside, an aperture 51, through which the belt 42 of the conveying means 32 can pass.

The pivoting arrangement 30, with reference to FIGS. 5 to 10, functions as follows:

In the first instance, a pack 10 is pushed into the holder 49 by way of the conveying means 32. The holder 49 here is arranged such that it is aligned with the route along which the packs 10 are transported on the belt 42. The holder 49 is of smaller dimensions in the conveying direction than the pack 10, the pack 10 projecting out of the holder 49 on the front side, as seen in the transporting direction.

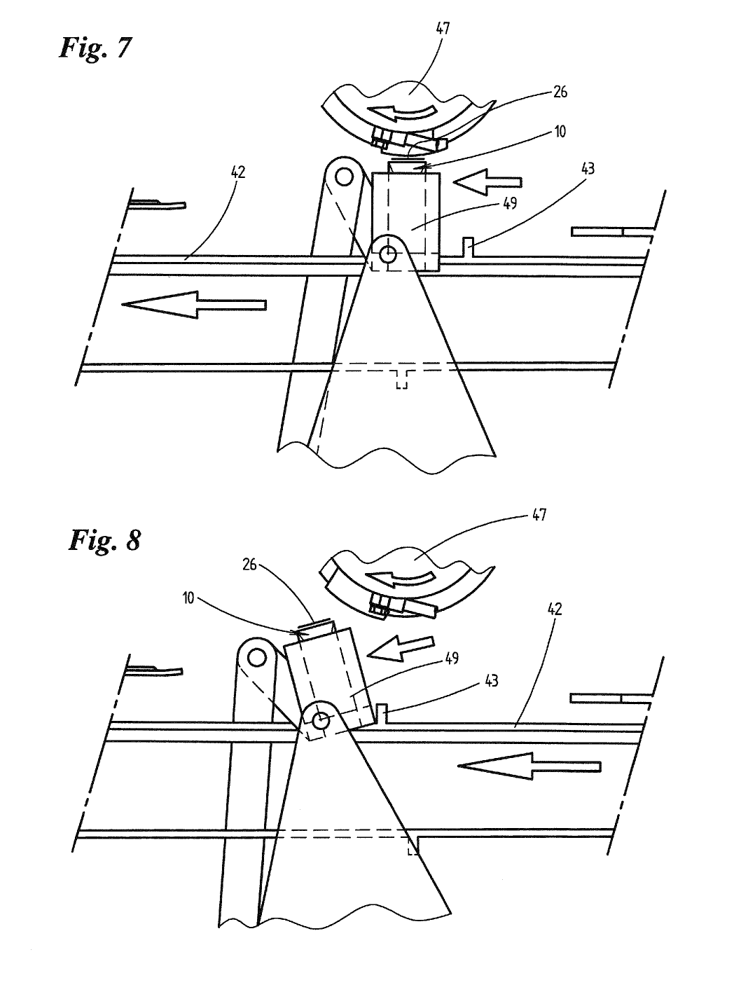

Once the pack 10 has been pushed in, the holder 49 is moved according to arrow 44 in the conveying direction of the packs 10 and, in the process, is pivoted about a horizontal axis into an upright position according to FIG. 7. In the upright position, the narrow side surface 22, which is to be provided with the label 26, is directed toward the transfer mechanism 47, which has transported the label 26 into an appropriate position, in which case contact between the narrow side surface 22 and the label 26 on the circumference of the transfer mechanism 47 causes the label 26 to be pressed against the narrow side surface 22 and applied there. A further special feature of this operation is that the holder 49 is accelerated in relation to the belt 42, in order to allow sufficient time for the holder 49 to pivot.

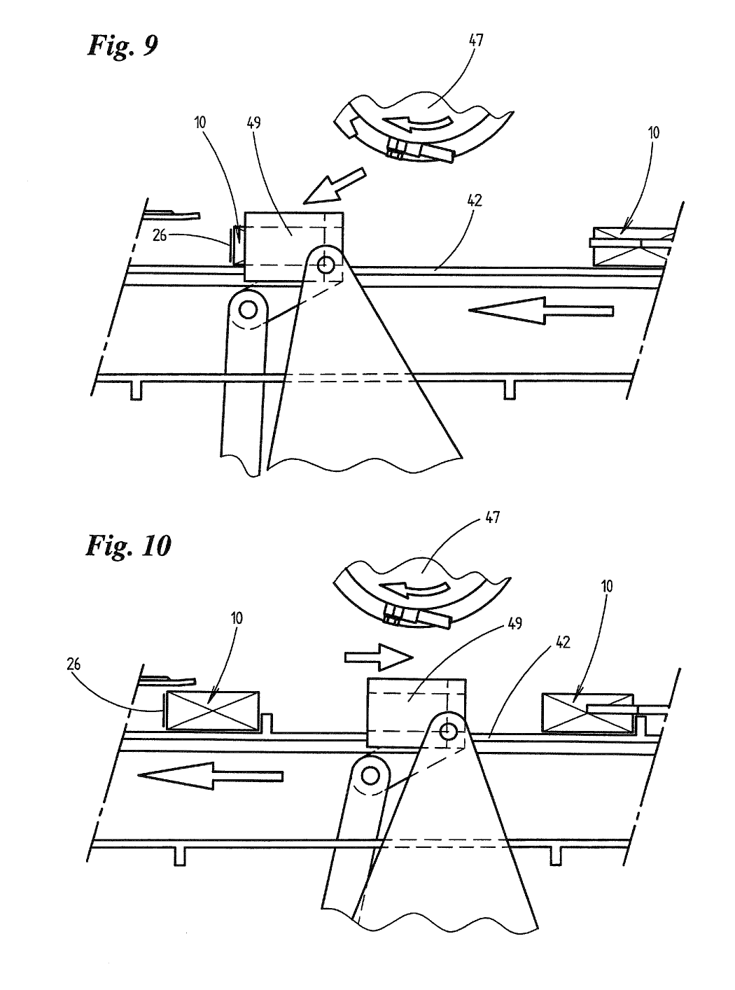

Once the label 26 has been applied, the holder 49 is transported further in the conveying direction of the packs 10 and, in the process, is rotated back into the original relative position, until it is aligned once again, according to FIG. 8, in relation to the route along which the packs 10 are transported. The movement path of the holder 49 here is coordinated such that the pack 10, in the position according to FIG. 9, is gripped on the rear side once again by the driver 43 and transported further in the conveying direction.

Thereafter, the holder 49, according to FIG. 10, is moved back, counter to the conveying direction of the packs 10, into the starting position according to FIG. 5, and the next pack 10 is thereby pushed in.

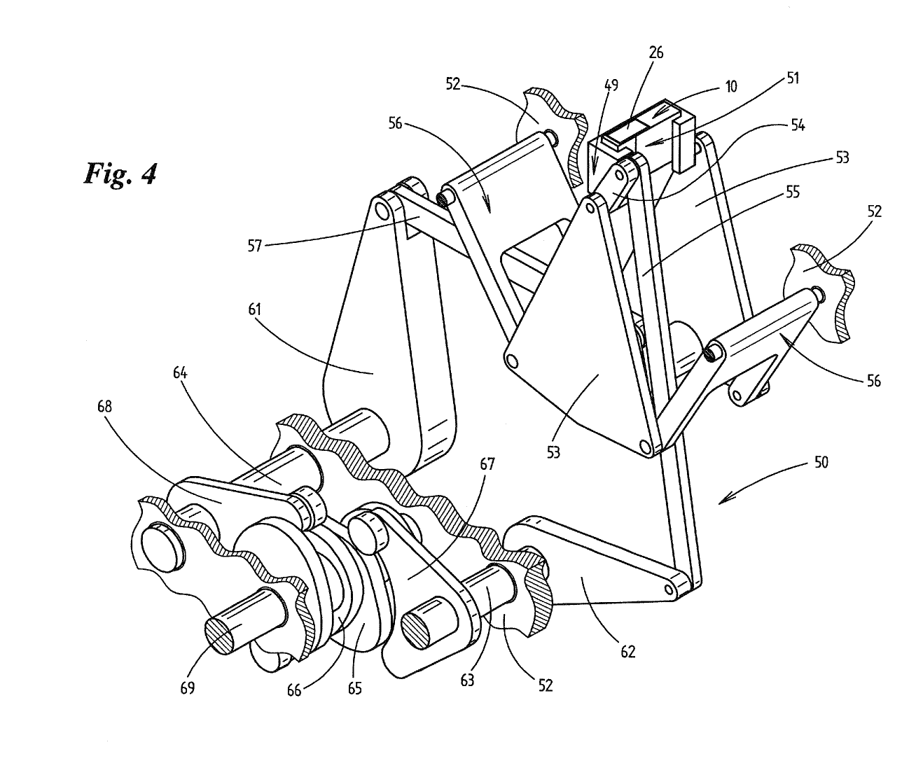

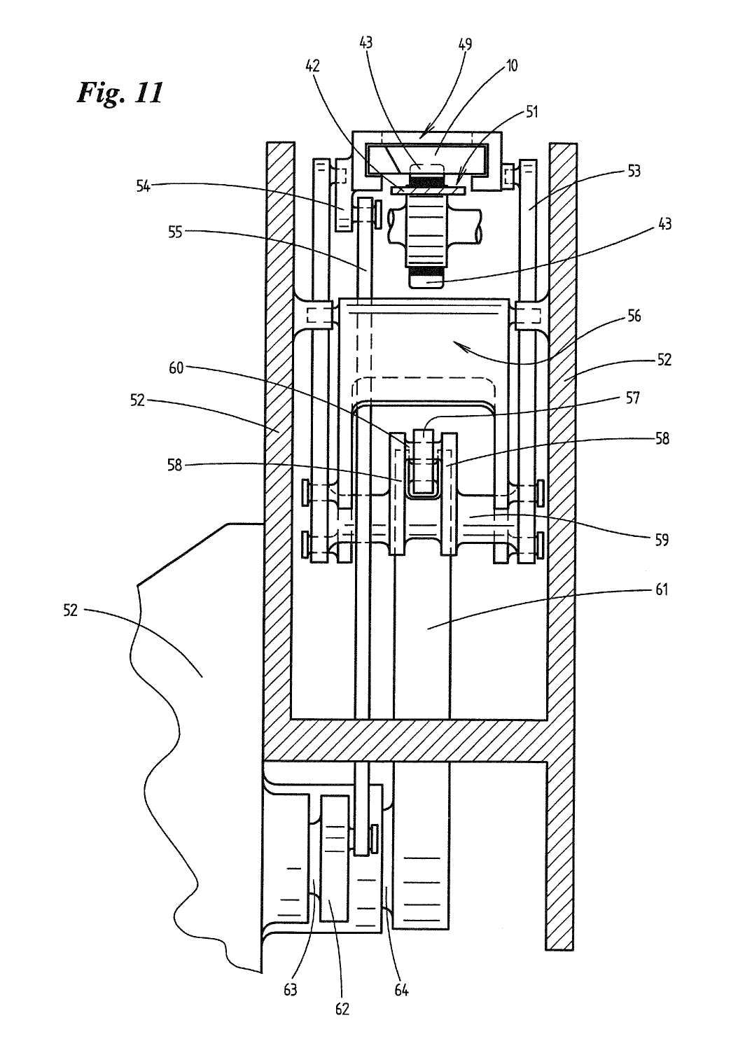

The gear mechanism 50, which is shown on an enlarged scale in FIGS. 4 and 11, is provided for the purpose of controlling the movement of the cassette-like holder 49. FIG. 3, which shows a side view, is also important in this respect. Much of the gear mechanism 50 is arranged in a housing 52 beneath the conveying means 32. Two plate-like rockers 53 form the central constituent part of the drive for the holder 49.

In the present case, the rockers 53 are approximately triangular, bearing points for connection to other mechanisms being provided in the corner regions.

The holder 49 is connected to the rockers 53 at two points. On one side, the holder 49 is connected, in a corner region of the same, to a rocker 53 directly, namely in the region of an upper corner point thereof. On the opposite side, the holder 49 is connected to the other rocker 53, by way of a corresponding corner region, via a short lever component 54. The lever component 54, in turn, is connected in a pivotable manner to a lever 55, which is coupled to the gear mechanism 50, for pivoting the holder 49 about an axis running through the two upper corner points of the rockers 53.

The rockers 53 are each mounted in a pivotable manner in the region of the lower two corner points. Two rocker bearings 56 are used for this purpose, these being mounted in a pivotable manner, on the one hand, on the housing 52 and, on the other hand, at in each case one corner point of the two rockers 53. In this way, the rockers 53 are mounted on the housing 52, via the rocker bearings 56, such that they can be pivoted back and forth on either side in the conveying direction of the pack.

The rockers 53 extend in an upright state to a location laterally on either side of the conveying means 32, for connection to the holder 49, which can be moved above the conveying means 32. Accordingly, the rockers are positioned in through-passages 75 of the housing 52.

The pivoting movement of the rocker 53 is produced via the coupling of a lever 57 to two lever components 58, which are arranged on a common axial element 59. The axial element 59 connects the two rockers 53 and is arranged on the lower periphery of the rockers 53, approximately in the longitudinal center. The lever components 58 are fixed on the axial element 59 and are connected by an axial element 60, to which the lever 57 is coupled.

The lever 55 for rotating the holder 49 and the lever 57 for pivoting the rockers 53 are each driven via pivoting levers 61, 62. The pivoting levers 61, 62 are each mounted on shafts 63, 64, which extend through a wall of the housing 52. The pivoting levers 61, 62 are rotated about the shafts 63, 64 via two cam plates 65, 66, which are coupled to the pivoting levers 61, 62 via cam levers 67, 68. The cam plates 65, 66 are located on a common driveshaft 69, which can be coupled to the central machine drive.

As can be seen from FIGS. 2 and 3, the packs 10 provided with the label 26 are transported away on the conveying means 32, in the conveying direction according to arrow 44, and fed to a folding turret 70. The packs 10 here are transported through a material strip 71 for the outer wrapper of the pack 10, and they carry along a corresponding printing carrier in a U-shaped manner in the process. Thereafter, the folding is completed in the known manner in the folding turret 70.

Of course, the apparatus, of which the essential parts are described above, can provide not just the narrow side surface 22, but also the opposite narrow side surface 23, with a label 26. It may be necessary, for this purpose, to change over the bearing points of the holder 49 on the rockers 53. It is conceivable, in particular, for the bearing points, rather than being arranged on the periphery, to be arranged approximately centrally on the sides of the holder 49. By virtue of the cam plates 65, 66 being exchanged, the direction of rotation of the holder 49 can be altered such that it is not the narrow side surface 22 but the opposite narrow side surface 23 which is directed toward the arrangement 31 for applying the labels 26. It is also conceivable for the label 26 to be applied correspondingly on the front side 16 or rear side 19 of the packs 10, wherein an appropriate configuration of the levers and cam plates means that all that is necessary is for the holder 49 to be rotated to a greater extent.

The second exemplary embodiment according to FIG. 12 differs from the exemplary embodiment according to FIGS. 1 to 11 only by way of the drive of the pivoting levers 61, 62. This is because the latter, in the second exemplary embodiment, are driven by a respective servomotor 72, 73.

Each servomotor 72, 73 can be controlled individually, in which case it is possible to control the movement path of the holder 49 and the rotation of the holder 49. It is conceivable to have, for example, an operating console, at which an operator can predetermine which side surface of the packs 10 should be provided with the label 26. Accordingly, it is possible in each case for use to be made of suitable programs for controlling the servomotors 72, 73, in order for the packs 10 to be provided with the label 26 either on one of the narrow side surfaces 22, 23 or on the front side 16.

Furthermore, it is also possible for the pivoting arrangement 30, as in the first exemplary embodiment, to be brought to a standstill, in order for packs 10 to be produced without the label 26. It is also conceivable, in such a configuration, for the rear sides 19 of the packs 10 to be provided with a label 26, by the arrangement 31 for applying the labels 26 being lowered in order to cover the distance from the packs 10. This variant is also conceivable in the case of the first exemplary embodiment.

### LIST OF DESIGNATIONS

10 Pack
11 Box part
12 Lid
13 Linear articulation
14 End wall
15 Base wall
16 Front side
17 Lid front wall
18 Box front wall
19 Rear side
20 Lid rear wall
21 Box rear wall
22 Narrow side surface
23 Narrow side surface
24 Lid side wall
25 Box side wall
26 Label
27 Weakening line
28 Transporting path
29 Turning arrangement
30 Pivoting arrangement
31 Arrangement
32 Conveying means
33 Wrapping machine
34 Conveying strand
35 Endless conveyor
36 Driver
37 Transporting belt
38 Conveying portion
39 Revolving star
40 Arm
41 Guide plate
42 Belt
43 Driver
44 Arrow
45 Label magazine
46 Removal roller
47 Transfer roller
48 Glue subassembly
49 Holder
50 Gear mechanism
51 Aperture
52 Housing
53 Rocker
54 Lever component
55 Lever
56 Rocker bearing
57 Lever
58 Lever component
59 Axial element
60 Axial element
61 Pivoting lever
62 Pivoting lever
63 Shaft
64 Shaft
65 Cam plate
66 Cam plate
67 Cam lever
68 Cam lever
69 Driveshaft
70 Folding turret
71 Material strip
72 Servomotor
73 Servomotor
74 Entry station
75 Through-passage

What is claimed is:

1. An apparatus for producing packs (10) for cigarettes, comprising:
a continuously driven conveying means (32), in the form of a transporting belt (42) with drivers (43), for transporting the packs (10);
an arrangement (31) for applying printing carriers, such as labels (26) or coupons, to a side surface of the packs (10), wherein the arrangement (31) for applying the printing carriers is arranged in the region of the conveying means (32), for the purpose of applying the printing carriers to a side surface of the pack (10), this side surface being directed toward the arrangement (31), during transportation along the conveying means (32); and
a pivoting arrangement (30) for altering the relative position of the packs (10), wherein the pivoting arrangement (30) is arranged in the region of the conveying means (32) and/or of the arrangement (31) for applying the printing carriers, and wherein the pivoting arrangement (30) is set up for receiving a respective pack (10) in a relative position appropriate for transportation on the conveying means (32), and for rotating the pack (10) into a relative position suitable for applying the printing carrier, and for further rotating the pack (10) into a relative position appropriate for further transportation on the conveying means (32).

2. The apparatus as claimed in claim 1, wherein:
the pivoting arrangement (30) comprises a holder (49) for a pack (10), into which the pack (10) can be pushed by the conveying means (32), and
the holder (49) can be rotated by a gear mechanism (50) such that the side surface of the pack (10) which is to be provided with the printing carrier can be directed toward the arrangement (31) for applying the printing carriers and, once the printing carrier has been applied, can be rotated back into the original relative position, and the pack (10) can be transferred onto the conveying means (32).

3. The apparatus as claimed in claim 1 or 2, wherein:
the packs (10) are arranged on the conveying means (32) in a state in which they lie flat and have a narrow side surface (22) oriented in the conveying direction, and,
by means of the pivoting arrangement (30), the packs (10) can be directed, with a narrow side surface (22) oriented upward, toward the arrangement (31) for applying the printing carriers, this arrangement being arranged above the conveying means (32).

4. The apparatus as claimed in claim 1 or 2, further comprising an entry station (74) and a turning arrangement (29), wherein the packs (10) are accumulated in the region of the entry station (74) and can be fed individually to the turning arrangement (29) for rotating and separating the packs (10) and transferring the packs (10) onto the conveying means (32).

5. The apparatus as claimed in claim 2, further comprising a rocker (53), wherein:
the holder (49) for the pack (10) is mounted on the rocker (53) such that the holder (49) can be pivoted on either side of the conveying means (32),
the rocker (53) is mounted in a pivotable manner on rocker bearings (56) and can be moved along an imaginary curve, together with the holder (49), via a drive, and
the holder (49) for the packs (10) can be rotated about the bearing point on the rocker (53) via a lever (55).

6. The apparatus as claimed in claim 5, wherein the lever (55) for rotating the holder (49) and a lever (57) for moving the rocker (53) can be driven by a gear mechanism (50) with a common drive.

7. The apparatus as claimed in claim 5, wherein the lever (55) for rotating the holder (49) and a lever (57) for moving the rocker (53) can be driven by separate drives.

8. The apparatus as claimed in claim 1 or 2, wherein, once the printing carrier has been applied, the packs (10) can be fed to an arrangement (33) for wrapping the packs (10) in an outer wrapper.

9. A method of producing packs (10) for cigarettes, comprising:
transporting the packs (10) continuously along a conveying means (32) in the region of an arrangement (31) for applying printing carriers, such as labels (26) or coupons, to side surfaces of the packs (10);
rotating the packs (10) in respect of their relative position in the region of a pivoting arrangement (30), during transportation along the conveying means (32), such that the side surfaces of the packs (10) which are to be provided with the printing carriers are directed toward the arrangement (31) for applying the printing carriers; and
rotating the packs (10) using the pivoting arrangement (30), once the printing carriers have been applied, into a relative position for further transportation on the conveying means (32) into the original relative position on the conveying means (32).

10. The method as claimed in claim 9, further comprising:
pushing the packs (10) from the conveying means (32) into a holder (49) of the pivoting arrangement (30); and
by virtue of the holder (49) being rotated in relation to the conveying means (32), moving the packs (10) into a relative position for applying the printing carriers with a corresponding side surface of the pack (10) oriented upward in the direction of the arrangement (31) for applying the printing carriers.

11. The method as claimed in claim 10, further comprising:
in addition to being rotated, accelerating the holder (49) in relation to the conveying means (32) in order to move the pack (10) into the relative position for applying the printing carriers; and
once the printing carriers have been applied and the packs (10) have been transferred onto the conveying means (32), moving the holder (49) back into a starting position for receiving the next pack (10).

12. The method as claimed in claim 9, further comprising, once the printing carriers have been applied, transferring the packs (10) once again onto the conveying means (32) in order to be fed to a wrapping machine (33) for an outer wrapper.

13. The method as claimed in claim 9, 10, 11, or 12, further comprising:
transporting the packs (10) closely together; and then
by means of a turning arrangement (29), separating and rotating and transferring the packs (10) onto the conveying means (32) for applying the printing carriers.

14. The method as claimed in claim 9, 10, 11, or 12, further comprising, for the purpose of producing packs (10) without printing carriers, positioning the holder (49) for the packs (10) on the conveying means (32) at a fixed location in the conveying path of the packs (10) such that the packs (10) are conveyed through the fixed-location holder (49) by way of the conveying means (32).

15. The apparatus as claimed in claim 7, wherein the separate drives are individually actuable servomotors (72, 73).

16. The apparatus as claimed in claim 8, wherein the outer wrapper is transparent.

17. The method as claimed in claim 10, wherein the corresponding side surface of the pack (10) is a narrow side surface (22) of the pack (10).
